(19) United States
(12) Patent Application Publication
(10) Pub. No.: US 2019/0305832 A1
(43) Pub. Date: Oct. 3, 2019

(54) WIRELESS TELECOMMUNICATIONS SYSTEM AND TRANSMISSION PROTOCOL FOR USE WITH SAME

(71) Applicants: Michail Matthaiou, Belfast (GB); Hien Quoc Ngo, Belfast (GB); Chung Duc Ho, Thu Dau Mot City (VN); Long Dinh Nguyen, Dinh Quan District (VN)

(72) Inventors: Michail Matthaiou, Belfast (GB); Hien Quoc Ngo, Belfast (GB); Chung Duc Ho, Thu Dau Mot City (VN); Long Dinh Nguyen, Dinh Quan District (VN)

(21) Appl. No.: 15/939,640

(22) Filed: Mar. 29, 2018

(51) Int. Cl. H04B 7/0452; H04B 7/06; H04B 7/08; H04L 1/00

(52) U.S. Cl. CPC H04B 7/0452; H04L 1/0048; H04B 7/0848; H04B 7/0615

(57) ABSTRACT

A transmission protocol for a multi-way massive MIMO relay system uses linear processing, self-interference cancelation and successive cancelation decoding to significantly reduce the number of time-slots required for data exchange amongst user devices compared to that for the conventional data transmission protocol. As a result, the spectral efficiency of the system is significantly increased.

### FIELD OF THE INVENTION

This invention relates to telecommunications systems, and in particular to multi-way relaying systems. The invention relates especially to multi-way Massive MIMO relaying systems.

### BACKGROUND TO THE INVENTION

Multi-way relaying has become one of the most promising technologies for next generation wireless systems, for its ability to reliably exchange information among many users and to achieve very high sum spectral efficiency. Many users located in geographically separated locations can exchange their data by using one or several sharing relay networks at the same time-frequency resource. The relay nodes are used to reduce the effect of path loss, and hence, many users can communicate with each other in large regions. Multi-way relaying networks can offer a high spectral efficiency by using linear processing at the relay.

In recent years, massive multiple-input multiple-output (MIMO) technology has been extensively investigated to scale-up the system throughput. In massive MIMO, many users are simultaneously served in the same frequency resource by a base station, equipped with many antennas. By using a very large antenna array at the base station, the channel vectors between the users and base station antenna array become pairwisely (nearly) orthogonal. Therefore, at the base station the resulting inter-user interference and noise are negligible, compared to the desired signal. The desired signals can be steered towards the target users in the downlink, and the undesired signals can be projected onto the orthogonal space to reduce their effects. Thus, the spectral and energy efficiencies of massive MIMO systems can increase ten or even hundred times compared to that of conventional multi-user MIMO systems without exacerbating the system complexity. As a consequence, massive MIMO is considered as a key technology for 5th-generation (5G) wireless communication systems.

The combination between multi-way relay networks and massive MIMO technology, known as multi-way massive MIMO relaying, has attracted a significant amount of research interest, since it offers substantial system performance gains in terms of spectral and energy efficiency, and transmit power reductions. In known systems, however, a conventional transmission protocol is used that requires in total of K time-slots for information exchange among K users.

It would be desirable to provide a system and transmission protocol that requires fewer time slots for information exchange amongst users, since this increases the spectral efficiency of the system.

### SUMMARY OF THE INVENTION

A first aspect of the invention provides a method of communicating signals amongst a plurality of user communication devices across a wireless communications network using a telecommunications relay station, the method comprising:

transmitting, from each of said user devices, a respective user signal to said relay station;
broadcasting, from said relay station to each of said user devices, the user device signals over a plurality of transmission time slots,
wherein said broadcasting involves broadcasting in each of said time slots a respective broadcast signal comprising a combination of said received user device signals,
the method further comprising:
receiving, at each of said user devices in each time slot, the respective broadcast signal for the respective time slot, and
for a first of said time slots, at each of said user devices,
removing, from the respective received broadcast signal, the respective user signal of the respective user device, and subsequently
detecting, from the respective received broadcast signal, a respective user signal from another of said user devices, and
   for subsequent time slots, at each of said user devices,
removing, from the respective received broadcast signal, the respective user signal of the respective user device,
removing, from the respective received broadcast signal, the or each respective user signal from another of said user devices detected in the or each previous time slot, and subsequently
detecting, from the respective received broadcast signal, a respective user signal from another of said user devices,
   and determining, at each user device, from the respective user signal from said another of said user devices detected in each previous time slot, and from the respective received broadcast signals for said first time slot and said subsequent time slots, the respective user signal of each user device in respect of which the respective user signal has not been detected.

In preferred embodiments there are K (where the value of K may be any number) of said user devices, and said plurality of transmission time slots consists of ┌(K−1)/2┐ time slots.

In preferred embodiments, said determining involves determining the respective user signal of K−┌(K−1)/2┐−1 user devices in respect of which the respective user signal has not been detected.

Said determining typically involves calculating the respective user signals using linear processing, preferably zero-forcing linear processing, alternatively maximum-ratio combining (MRC) or minimum mean-squared error (MMSE).

Said respective broadcast signal typically comprises a linear combination of said received user device signals, linear combination being created, for example, using maximum-ratio combining (MRC) or minimum mean-squared error (MMSE) linear processing, or other linear processing technique.

In preferred embodiments, said detecting comprises decoding the respective received broadcast signal to determine the respective user signal from another of said user devices. Said decoding may involve using maximum likelihood decoding, minimum distance encoding or syndrome encoding.

In preferred embodiments, said relay station is a multi-way massive MIMO relay station.

Typically, said transmitting and said broadcasting are performed using a common frequency band.

Typically said transmitting and said broadcasting are performed using time-division duplexing (TDD).

From another aspect the invention provides a telecommunications system comprising a plurality of user communication devices in communication across a wireless communications network using a telecommunications relay station, wherein each of said user devices is configured to transmit a respective user signal to said relay station, said relay station being configured to broadcast, in each of a plurality of time slots to each of said user devices, a respective broadcast signal comprising a combination of said user device signals,

and wherein each of said user devices is configured to receive, in each time slot, the respective broadcast signal for the respective time slot, and
for a first of said time slots,
to remove, from the respective received broadcast signal, the respective user signal of the respective user device, and subsequently
to detect, from the respective received broadcast signal, a respective user signal from another of said user devices, and
   for subsequent time slots,
to remove, from the respective received broadcast signal, the respective user signal of the respective user device,
to remove, from the respective received broadcast signal, the or each respective user signal from another of said user devices detected in the or each previous time slot, and subsequently
to detect, from the respective received broadcast signal, a respective user signal from another of said user devices,
   and wherein each user device is configured to determine, from the respective user signal from said another of said user devices detected in each previous time slot, and from the respective received broadcast signals for said first time slot and said subsequent time slots, the respective user signal of each user device in respect of which the respective user signal has not been detected.

Preferred embodiments comprise a multi-way decode and forward (DF) relay system with massive, or very large, antenna arrays at the relay station, i.e. a multi-way massive MIMO relay system. Advantageously, the system uses a transmission protocol that requires a relatively low number of time-slots, and so increases substantially the spectral efficiency of the system.

The preferred transmission protocol uses massive MIMO technology and successive cancelation decoding. In preferred embodiments, the number of time-slots required for data exchange among user devices is significantly reduced (i.e. by approximately a factor of 2), compared to that for the conventional data transmission protocol. As a result, compared to conventional systems, preferred systems embodying the invention provide a double sum spectral efficiency, when the number of antennas at the relay is large.

In preferred embodiments, each user device and the relaying base station operate in half-duplex and time-division duplexing (TDD) modes. To exchange the information among all users (or user devices), preferred embodiments employ a transmission protocol which combines massive MIMO technology with linear processing, self-interference cancelation, and successive cancelation decoding.

Notation: upper and lower case boldface letters are used to denote matrices and vectors, respectively. The superscript (⋅)^{H} represents the conjugate transpose. The notations E{⋅} and Tr(⋅) stand for the expectation and trace operators, respectively. The symbol ∥⋅∥ represents the norm of a vector, and ┌⋅┐ represents the ceiling function. zₖ denotes the k-th column of matrix Z, and I_{K} denotes a K×K identity matrix. Z∘Y denotes the Hadamard product of matrices Z and Y.

### BRIEF DESCRIPTION OF THE DRAWINGS

An embodiment of the invention is now described by way of example and with reference to the accompanying drawings in which:

FIG. 1 is a schematic view of a system embodying one aspect of the invention;

FIG. 2 is a flow chart illustrating the preferred transmission protocol; and

FIG. 3 is a schematic illustration of a transmission protocol embodying another aspect of the invention.

### DETAILED DESCRIPTION OF THE DRAWINGS

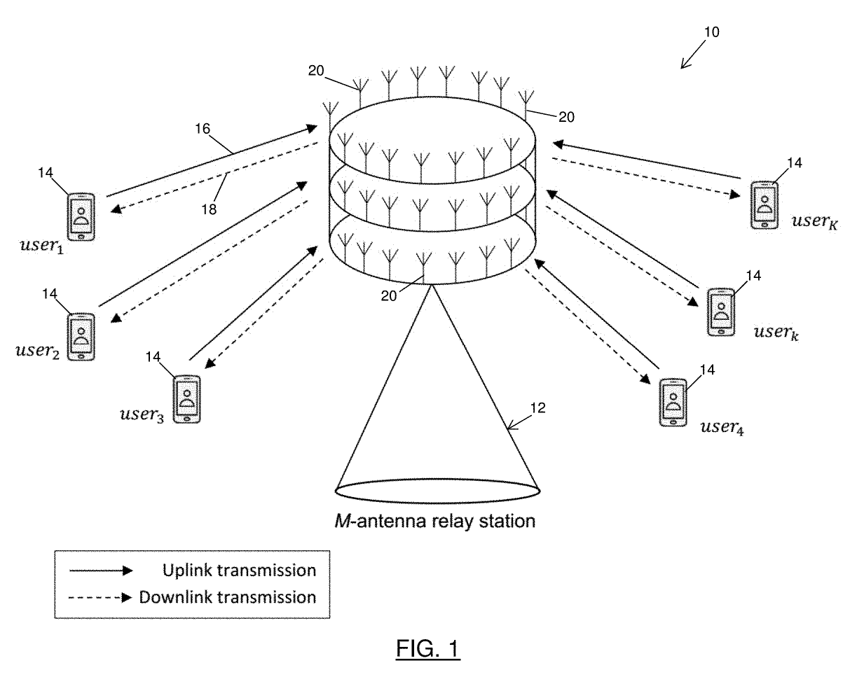

Referring now to FIG. 1 of the drawings, there is shown, generally indicated as 10, a telecommunications system embodying one aspect of the present invention. The system 10 comprises a relaying base station 12, which may be referred to as a base station or a relay station, in communication with multiple user communication devices 14 via a wireless telecommunications network (represented by uplink and downlink transmissions 16, 18), which may comprise a cellular telephone network and/or a wireless data network. Each user device 14 may be a telephone, e.g. a cell phone or smart phone, or any other device capable of wireless communication with the system 10. Each user device 14 is assumed to be used by a respective user (not shown) of the system 10.

The relay, or base, station 12 has multiple antennas 20 and supports multiple-input multiple-output (MIMO) wireless technology. The number of antennas may vary from embodiment to embodiment but is typically in the order of hundreds or thousands. As such the number M of antennas may be said to be “massive”. The relay station 12 may therefore be said to include a massive antenna array and may be referred to as a massive MIMO relay station. The relay station 12 also includes one or more wireless transmitters and receivers (or transceivers) (not shown), and one or more controllers (not shown), as 35 would be apparent to a skilled person. The controller(s) may take the form of a suitably programmed computing device and may be programmed to control the operation of the relay station 12 as described hereinafter, alternatively the controller(s) may be implemented in hardware (for example as one or more suitably designed integrated circuit, e.g. an ASIC or FPGA), or as a combination of hardware and software.

The number of user devices 14, or users, may vary from embodiment to embodiment and from time to time but is typically in the order of tens or hundreds. Accordingly, in preferred embodiments, the system 10 may be referred to as a multi-way massive MIMO relaying system. Massive MIMO systems may also be referred to as Large-Scale Antenna Systems, Very Large MIMO, Hyper MIMO, Full-Dimension MIMO and ARGOS.

The M-antenna relay station 12 enables communication between the K geographically distributed users 14. Conventional linear processing may be used at the relay station 12 for decoding received signals and precoding signals for transmission. The relay station 12 may include any suitably programmed, conventional computing device(s) (not shown) and/or circuitry for this purpose, e.g. the controller, or one of the controllers in embodiments where there is more than one.

The system 10 supports an uplink mode whereby the K users 14 may simultaneously transmit signals to the relay station 12. Linear decoders (e.g. maximum-ratio, zero-forcing, and/or minimum mean-squared error decoders) are used at the relay station 12 to detect all transmitted signals from all users 14. The system 10 also supports a downlink mode whereby the relay station 12 broadcasts K signals to the K users 14. Linear precoders (e.g. maximum-ratio, zero-forcing, and/or minimum mean-squared error precoders) are used at the relay station 12 on the signals to be transmitted, to facilitate targeting of the signals at the users.

In preferred embodiments, the system 10 is a multi-way decode-and-forward (DF) massive MIMO relaying system, where Ksingle-antenna users 14 exchange their bearing-data amongst themselves via the assistance of the common relay station 12 using the same time-frequency resource, i.e. using different time slots in the same frequency band. In preferred embodiments, each user device 14 and the relay station 12 operate in half-duplex mode. In preferred embodiments, each user device 14 and the relaying relay station 12 support time-division duplexing (TDD). As such the uplink 16 and downlink 18 are separated from each other by the allocation of respective time slots in the frequency band being used for transmission. Signals are transmitted between the relay station 12 and the user devices 14 in time-slots. It is assumed that perfect channel state information (CSI) is available at the user devices 14 and at the relay station 12. It may be assumed that direct links (user-to-user links) do not exist due to large path loss and/or heavy shadowing.

The wireless communication channels between the user devices 14 and the relay station 12 may experience both large-scale fading (including path loss and shadowing) and small-scale fading (e.g. Rayleigh fading). In the following analysis, gₘₖ is the channel coefficient between the k-th user and the m-th antenna at the relay. Then,

gₘₖ=\sqrt{βₖ}hₘₖ, m=1, . . . , M; k=1, . . . , K, [1]

where hₘₖ˜CN(0, 1) represents the small-scale fading, and βₖ models the large-scale fading, which does not depend on m∈{1, 2, . . . , M} as the distance between the k-th user and the relay are much larger than the antenna spacing. Furthermore, βₖ is assumed to be constant over many coherence time intervals and known a priori as it changes very slowly with time. In matrix form,

G=HD^{1/2}, [2]

where G∈C^{M×K} is the channel matrix from the K users 14 to M antennas at the relay station 12, H∈C^{M×K} is the small-scale fading matrix, and D∈C^{K×K} is the large-scale fading matrix which is a diagonal matrix with [D]ₖₖ=βₖ. The (m, k)-th element of G and H are gₘₖ and hₘₖ, respectively.

Multi-way relaying involves multiple users (the K users 14 in the present example) exchanging data via the relaying relay station 12. In other words, each user 14 wants to get information transmitted from the other K−1 users 14, i.e. to detect the signals transmitted by the K−1 other users. To this end, the system 10 implements a transmission protocol having two phases: a multiple-access (MA) phase and a broadcast (BC) phase. In the MA phase, all K users 14, sharing the same frequency band, simultaneously transmit their data to the relay station 12. Then, the relay station 12 uses a linear decoding technique to detect all signals from all users. In the BC phase, the relay station 12 transmits, or broadcasts, all signals to all users in a plurality of time-slots. In each time-slot, the relay station 12 broadcasts a composite signal comprising a combination of all K signals from each of the K users 14.

A preferred transmission protocol for the Multiple-Access (MA) phase is now described. In the MA phase, all K users (or more particularly all K user devices 14) transmit their signals in a single time-slot to the relay relay station 12. Letting xₖ be the signal transmitted from user k, where E{|xₖ|²}=1, then the Mx1 received vector at the relay station 12 can be written as

$${y}_{R} = {\sum }_{k = 1}^{K} \sqrt{{P}_{u , k}} {g}_{k} {x}_{k} + {n}_{R} , \qquad [ 3 ]$$

where P_{u,k} is the normalized transmit power of the k-th user (normalized over the noise power), gₖ is the k-th column of the channel matrix G, and n_{R}∈C^{Mx1} is the noise vector with independent and identically distributed (i.i.d.) CN(0, 1) elements.

From the received signal vector given in equation (3), the relay station 12 detects all K signals xₖ, k=1, . . . , K. By way of example, the relay station 12 uses a maximum-ratio combining scheme to detect xₖ, although other linear decoding schemes may alternatively be used. Maximum-ratio combining is relatively simple and can be implemented in a distributed manner. Advantageously, the maximum-ratio combining technique works well with massive antenna arrays at the relay station 12. Using the maximum-ratio combining scheme, the received signal vector y_{R} is first multiplied with the channel G^{H} as

$$\begin{matrix}r = {G}^{H} {y}_{R} \\ = {G}^{H} {\sum }_{k = 1}^{K} \sqrt{{P}_{u , k}} {g}_{k} {x}_{k} + {G}^{H} {n}_{R} .\end{matrix} \qquad [ 4 ]$$

Then xₖ is detected from the k-th element of r, denoted by rₖ. From equation [4], rₖ can be written as

$${r}_{k} = \sqrt{{P}_{u , k}} {‖ {g}_{k} ‖}^{2} {x}_{k} + {\sum }_{i = 1 , i \neq k}^{K} \sqrt{{P}_{u , i}} {g}_{k}^{H} {g}_{i} {x}_{i} + {g}_{k}^{H} {n}_{R} , \qquad [ 5 ]$$

Thus, the uplink spectral efficiency (measured in bit/s/Hz) of the k-th user is

$${R}_{k}^{ul} = 𝔼 \{ {log}_{2} ( 1 + \frac{{P}_{u , k} {‖ {g}_{k} ‖}^{4}}{{\sum }_{i = 1 , i \neq k}^{K} {P}_{u , i} {\vert {g}_{k}^{H} {g}_{i} \vert}^{2} + {‖ {g}_{k} ‖}^{2}} ) \} \qquad [ 6 ]$$

Jensen's inequality can be used to obtain a rigorous lower bound of the spectral efficiency of equation [6] in a simple closed-form expression as:

$$\begin{matrix}{R}_{k}^{ul} \geq {\tilde{R}}_{k}^{ul} = {log}_{2} ( 1 + 𝔼 {\{ \frac{{\sum }_{i = 1 , i \neq k}^{K} {P}_{u , i} {\vert {g}_{k}^{H} {g}_{i} \vert}^{2} + {‖ {g}_{k} ‖}^{2}}{{P}_{u , k} {‖ {g}_{k} ‖}^{4}} \}}^{- 1} ) \\ = {log}_{2} ( 1 + \frac{{P}_{u , k} ( M - 1 ) {β}_{k}}{{\sum }_{i = 1 , i \neq k}^{K} {P}_{u , i} {β}_{i} + 1} ) .\end{matrix} \qquad [ 7 ]$$

In alternative embodiments, other conventional transmission protocols may be used in the MA phase.

For the broadcast (BC) phase, conventional transmission protocols require that the relay station 12 uses K−1 time slots in order to broadcast all signals (which are decoded in the MA phase) to all K users 14. Therefore a total of K time-slots is required for the information exchange amongst the K users 14 (1 slot for the MA phase and K−1 slots for the BC phase).

There is now described an advantageous data transmission protocol for use in the BC phase. The preferred BC phase transmission protocol uses a successive cancelation decoding principle. As a result ┌(K−1)/2┐ time slots are required for the BC phase (an additional one time slot being required for the MA phase as described above). In preferred embodiments, to ensure that aggregated interference, including self-interference and inter-user interference, does not affect the system performance, the properties of massive MIMO are applied together with successive self-interference cancelation, and zero-forcing decoding technique at the user devices 14. Therefore, as the number of antennas M increases to infinity, the inter-user interference can be minimized significantly.

In the BC phase, the relay station 12 broadcasts the signals (that have been detected/decoded in the MA phase) to all of the user devices 14 in ┌(K−1)/2┐ time slots. According to the preferred BC phase transmission protocol, at a given time-slot, the k-th user device 14 subtracts all interference sources caused by signals decoded in previous time-slots prior to decoding the desired signal. In addition, after ┌(K−1)/2┐ time-slots and with successive interference cancellation, the k-th user 14 has received ┌(K−1)/2┐ signals, and each signal is a linear combination of K−┌(K−1)/2┐−1 symbols. More particularly, each signal received by the user devices 14 is a linear combination of K symbols. However, each user device 14 has detected [(K−1)/2] symbols from the previous [(K−1)/2] time-slots and, in addition, knows its own transmitted symbols. Therefore, each user device 14 can use successive interference cancellation as described herein to remove these [(K−1)/2]+1 symbols. As a result, the received signal, after cancellation, at each user 14 is a linear combination of K−[(K−1)/2]−1 symbols. Since ┌(K−1)/2┐≥K−┌(K−1)/2┐−1, the k-th user can use a linear decoding technique, preferably the zero-forcing technique, to decode all remaining symbols without any inter-user interference.

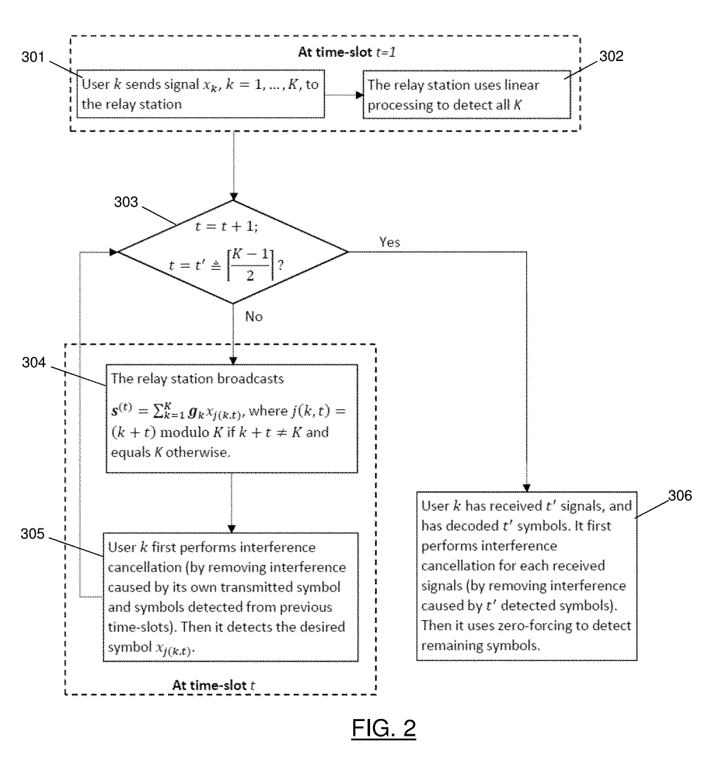

FIG. 2 shows a flow chart illustrating the preferred transmission protocol. In time slot t=1 the MA phase is performed in which each user device 14 (user k, where k=1, . . . , K) sends its respective signal xₖ to the relay station 12 (301). The signals xₖ transmitted by the user devices 14 may be said to comprise symbols, more particularly symbols representing the respective digital signal. Therefore, in time slot t=1, each user device 14 transmits to the relay station 12 a respective symbol xₖ, the symbol being the user's signal for the respective transmission time slot. The relay station 12 receives the transmissions from the user devices 14 and decodes the received information (which is typically in the form of a signal vector) to detect each of the K user signals xₖ (302). The relay station 12 may use a linear processing (or linear decoding) technique, for example the maximum-ratio combining technique, for this purpose.

For subsequent time slots up to but not including time slot ┌(K−1)/2┐ (303), the relay station 12 broadcasts a signal vector s to all K user devices 14 (304). The signal vectors is a composite signal formed from each of the K received and decoded signals xₖ. The relay station 12 creates the signal vector s using a linear processing technique, for example maximum-ratio combining (MRC) or minimum mean-square error (MMSE) processing. In each time slot, the relay station 12 broadcasts a different signal vector s, i.e. a different linear combination of the user signals, or symbols, xₖ, to the user devices 14 in order to transmit to each user device 14 the K−1 symbols xₖ transmitted by the other user devices 14. In the more detailed description given below, the respective symbol for each time slot is denoted as x_{j(k,t)}. For example, x_{j(k,t)} is one symbol of the set of K symbols {x₁, x₂, . . . , x_{K}} where xₖ is the symbol transmitted by the k-th user. In the BC phase, at each time slot, the relay station 12 broadcasts a respective linear combination of {x₁, x₂, . . . , xₖ}. For example, at the first time-slot of BC phase, the relay station 12 may wants to send x₂ to user 1, x₃ to user 2, . . . , x_{K} to user K−1 and x₁ to user K, and creates the broadcast signal s as a corresponding linear combination of the symbols xₖ. At the second time slot, the relay station 12 may wants to send x₃ to user 1, x₄ to user 2, . . . , and x₂ to user K, and creates the broadcast signal s as a corresponding (different) linear combination of the symbols xₖ, and so on for each time slot of the BC phase.

In each time slot, each user device 14 receives the signal vector s for that time slot and performs interference cancelation on it, after which each user device 14 decodes, or detects, the respective symbol x_{j(k,t)} for that time slot (305). Detection of the desired symbol x_{j(k,t)} may be performed using any convenient decoding technique, for example maximum likelihood decoding, minimum distance encoding or syndrome encoding. The interference cancelation involves removing its own transmitted signal xₖ, and each symbol (x_{j(k,t-1)} etc.) that it has detected in previous time slots.

In time slot ┌(K−1)/2┐, each user device 14 has received ┌(K−1)/2┐ signals, and has decoded ┌(K−1)/2┐ symbols. Each user device 14 first performs interference cancellation for each received signal (by removing interference caused by ┌(K−1)/2┐ detected symbols). Then it uses the zero-forcing technique (or any other suitable linear processing technique e.g. maximum ratio combining (MRC) or minimum mean-squared error (MMSE)) to detect the remaining K−┌(K−1)/2┐−1 symbols (306).

The preferred transmission protocol for the BC phase is described in more detail below.

1) In a first time-slot of the BC phase: The relay station 12 wants to send x_{j(k,t)} to the k-th user device 14, for k=1, . . . , K, where

$$j ( k , t ) {=}^{Δ} \{ \begin{matrix}( k + t ) modulo K , & if ( k + t ) \neq K \\ K , & otherwise\end{matrix} . \qquad [ 8 ]$$

To do this, the relay station 12 uses a linear precoding technique and forms a signal vector to broadcast to the user devices 14. In the present example, the linear precoding technique is assumed to be maximum-ratio combining (MRC) and so the signal vector s may be given as as:

$${s}^{( 1 )} = {\sum }_{i = 1}^{K} \sqrt{{η}_{j ( i , 1 )}^{( 1 )}} {g}_{i} {x}_{j ( i , 1 )} , \qquad [ 9 ]$$

where

{η_{j(i,1)}⁽¹⁾}, i=1, . . . , K,

are the power control coefficients at the relay station 12 in the first time-slot which are chosen to satisfy a given power constraint at the relay:

$$𝔼 \{ {‖ {s}^{( 1 )} ‖}^{2} \} \leq {P}_{r , th} \\ or , \\ M {\sum }_{i = 1}^{K} {η}_{j ( i , 1 )}^{( 1 )} {β}_{i} \leq {P}_{r , th} . \qquad [ 10 ]$$

Then the k-th user device 14 receives

$${y}_{k}^{( 1 )} = {g}_{k}^{H} {s}^{( 1 )} + {n}_{k}^{( 1 )} = {\sum }_{i = 1}^{K} \sqrt{{η}_{j ( i , 1 )}^{( 1 )}} {g}_{k}^{H} {g}_{i} {x}_{j ( i , 1 )} + {n}_{k}^{( 1 )} , \qquad [ 11 ]$$

where nₖ⁽¹⁾˜CN(0; 1) is the additive noise at the k-th user 14 in the first time-slot. Before detecting the desired signal x_{j(k,t)} the k-th user 14 performs self-interference cancelation by subtracting its transmitted signal xₖ (or x_{j(k-1,1)}) from yₖ⁽¹⁾. After self-interference cancelation, the received signal at the k-th user 14 becomes

$$\begin{matrix}{\tilde{y}}_{k}^{( 1 )} = \sqrt{{η}_{j ( k , 1 )}^{( 1 )}} {‖ {g}_{k} ‖}^{2} {x}_{j ( k , 1 )} + {\sum }_{i = 1 \\ j ( i , 1 ) ∉ {V}_{k , 1}}^{K} \sqrt{{η}_{j ( i , 1 )}^{( 1 )}} {g}_{k}^{H} {g}_{i} {x}_{j ( i , 1 )} + {n}_{k}^{( 1 )} , \\ where & [ 12 ] \\ {V}_{k , t} {=}^{Δ} \{ j ( k - t , t ) , j ( k - t + 1 , t ) , … , j ( k , t ) \} . & [ 13 ]\end{matrix}$$

The first term of equation [12] represents the desired signal, the second and third terms are interference and noise, respectively. Thus, we obtain the corresponding spectral efficiency as

$${R}_{k}^{dl , ( 1 )} = 𝔼 \{ {log}_{2} ( 1 + \frac{{η}_{j ( k , 1 )}^{( 1 )} {‖ {g}_{k} ‖}^{4}}{{\sum }_{i = 1 \\ j ( i , 1 ) ∉ {V}_{k , 1}}^{K} {η}_{j ( i , 1 )}^{( 1 )} {\vert {g}_{k}^{H} {g}_{i} \vert}^{2} + 1} ) \} \qquad [ 14 ]$$

2) In the second time-slot of the BC phase: after aiming to transmit x_{j(k,1)} to the k-th user 14 in the first time-slot, the relay station 12 next wants to send x_{j(k,2)} to the k-th user device 14, for k=1, . . . , K. So, the relay station 12 precodes (using a linear processing technique, which in this example is assumed to be maximum-ratio combining (MRC)) the transmitted signals as

$${s}^{( 2 )} = {\sum }_{i = 1}^{K} \sqrt{{η}_{j ( i , 2 )}^{( 2 )}} {g}_{i} {x}_{j ( i , 2 )} , \qquad [ 15 ]$$

where

{η_{j(i,2)}⁽²⁾}, i=1, . . . ,K,

are the power control coefficients at the relay in the second time-slot chosen to satisfy a given power constraint P_{r,th} at the relay station as

$$M {\sum }_{i = 1}^{K} {η}_{j ( i , 2 )}^{( 2 )} {β}_{i} \leq {P}_{r , th} . \qquad [ 16 ]$$

Then the k-th user receives

$${y}_{k}^{( 2 )} = {g}_{k}^{H} {s}^{( 2 )} + {n}_{k}^{( 2 )} = {\sum }_{i = 1}^{K} \sqrt{{η}_{j ( i , 2 )}^{( 2 )}} {g}_{k}^{H} {g}_{i} {x}_{j ( i , 2 )} + {n}_{k}^{( 2 )} . \qquad [ 17 ]$$

Since user device k knows its own transmitted signal xₖ (or x_{j(k-1,1)}) and the symbol detected in the first timeslot x_{j(k,1)}, it can perform interference cancelation by removing these symbols from yₖ⁽²⁾ before detecting the desired signal x_{j(k,2)}. After interference cancelation, the received signal at the k-th user device 14 becomes

$${\tilde{y}}_{k}^{( 2 )} = \sqrt{{η}_{j ( k , 2 )}^{( 2 )}} {‖ {g}_{k} ‖}^{2} {x}_{j ( k , 2 )} + {\sum }_{i = 1 \\ j ( i , 2 ) ∉ {V}_{k , 2}}^{K} \sqrt{{η}_{j ( i , 2 )}^{( 2 )}} {g}_{k}^{H} {g}_{i} {x}_{j ( i , 2 )} + {n}_{k}^{( 2 )} . \qquad [ 18 ]$$

The corresponding spectral efficiency of the k-th user in the broadcast phase at the second time-slot is given by

$${R}_{k}^{dl , ( 2 )} = 𝔼 \{ {log}_{2} ( 1 + \frac{{η}_{j ( k , 2 )}^{( 2 )} {‖ {g}_{k} ‖}^{4}}{{\sum }_{i = 1 \\ j ( i , 2 ) ∉ {V}_{k , 2}}^{K} {η}_{j ( i , 2 )}^{( 2 )} {\vert {g}_{k}^{H} {g}_{i} \vert}^{2} + 1} ) \} \qquad [ 19 ]$$

3) In the t-th time-slot of the BC phase: At the t-th time-slot, the relay station 12 intends to send x_{j(k,t)} to the k-th user, for k=1, . . . , K. After precoding (linear processing) the signal vector transmitted from the relay station 12 is

$${s}^{( t )} = {\sum }_{i = 1}^{K} \sqrt{{η}_{j ( i , t )}^{( t )}} {g}_{i} {x}_{j ( i , t )} . \qquad [ 20 ]$$

As before,

{η_{j(i,t)}^{(t)}}, i=1, . . . , K,

are the power control coefficients at the t-th time slot chosen to satisfy

$$M {\sum }_{i = 1}^{K} {η}_{j ( i , t )}^{( t )} {β}_{i} \leq {P}_{r , th} . \qquad [ 21 ]$$

Then the signal received at the k-th user 14 is

$${y}_{k}^{( t )} = {g}_{k}^{H} {s}^{( t )} + {n}_{k}^{( t )} = {\sum }_{i = 1}^{K} \sqrt{{η}_{j ( i , t )}^{( t )}} {g}_{k}^{H} {g}_{i} {x}_{j ( i , t )} + {n}_{k}^{( t )} , \qquad [ 22 ]$$

where

nₖ⁽¹⁾˜CN(0,1)

denotes the additive noise. At the t-th time-slot, the k-th user device 14 detected {x_{j(k,1)}, x_{j(k,2)}, . . . , x_{j(k,t-1)}} in previous time-slots. In addition, the k-th user 14 knows it own transmitted signal x_{j(k-1,1)}. So, user device k can remove these symbols from yₖ(t) before detecting x_{j(k,t)}. The received signal at the k-th user device 14 after interference cancelation is

$${\tilde{y}}_{k}^{( t )} = \sqrt{{η}_{j ( k , t )}^{( t )}} {‖ {g}_{k} ‖}^{2} {x}_{j ( k , t )} + {\sum }_{i = 1 \\ j ( i , 2 ) ∉ {V}_{k , t}}^{K} \sqrt{{η}_{j ( i , t )}^{( t )}} {g}_{k}^{H} {g}_{i} {x}_{j ( i , t )} + {n}_{k}^{( t )} . \qquad [ 23 ]$$

Therefore, the spectral efficiency of the k-th user at the t-th time-slot in the broadcast phase is given by

$${R}_{k}^{dl , ( t )} = 𝔼 \{ {log}_{2} ( 1 + \frac{{η}_{j ( k , t )}^{( t )} {‖ {g}_{k} ‖}^{4}}{{\sum }_{i = 1 \\ j ( i , t ) ∉ {V}_{k , t}}^{K} {η}_{j ( i , t )}^{( t )} {\vert {g}_{k}^{H} {g}_{i} \vert}^{2} + 1} ) \} . \qquad [ 24 ]$$

As can be seen from the foregoing, the k-th user device 14 knows its own transmitted symbols xₖ. Furthermore, it also knows its detected symbols in previous time-slots. Therefore the k-th user device 14 can remove these symbols before detecting the desired signal x_{j(k,t)}.

The spectral efficiency Rₖ^{dl,(t)} given by equation [24] can be lower bounded by

$${R}_{k}^{dl , ( t )} \geq {\tilde{R}}_{k}^{dl , ( t )} = {log}_{2} ( 1 + \frac{{η}_{j ( k , t )}^{( t )} ( M - 1 ) ( M - 2 ) {β}_{k}^{2}}{( M - 2 ) {β}_{k} {\sum }_{i = 1 \\ j ( i , t ) ∉ {V}_{k , t}}^{K} {η}_{j ( i , t )}^{( t )} {β}_{i} + 1} ) . \qquad [ 25 ]$$

4) After t′=┌(K−1)/2┐ time-slots, the k-th user has received t′ signals {yₖ⁽¹⁾, . . . , yₖ^{(t′)}}, where yₖ^{(t)} is given by equation [22] for t=1, . . . , t′. In addition, it has decoded t′ symbols {x_{j(k,1)}, x_{j(k,2)}, . . . , x_{j(k,t′)}}. Thus, the k-th user 14 can perform interference cancelation by subtracting all t′ detected symbols as well as it own transmitted symbol from each received signal, and obtain the following results:

$$\{ \begin{matrix}{\overline{y}}_{k , 1}^{( {t}^{′} )} = {\sum }_{i = 1 \\ j ( i , {t}^{′} ) ∉ {V}_{k , {t}^{′}}}^{K} \sqrt{{η}_{j ( i , {t}^{′} )}^{( {t}^{′} )}} {g}_{k}^{H} {g}_{j ( k , i - k )} {x}_{j ( i , {t}^{′} )} + {n}_{k , 1}^{( {t}^{′} )} \\ {\overline{y}}_{k , 2}^{( {t}^{′} )} = {\sum }_{i = 1 \\ j ( i , {t}^{′} ) ∉ {V}_{k , {t}^{′}}}^{K} \sqrt{{η}_{j ( i , {t}^{′} )}^{( {t}^{′} - 1 )}} {g}_{k}^{H} {g}_{j ( k , i - k + 1 )} {x}_{j ( i , {t}^{′} )} + {n}_{k , 2}^{( {t}^{′} )} \\ ⋮ \\ {\overline{y}}_{k , {t}^{′}}^{( {t}^{′} )} = {\sum }_{i = 1 \\ j ( i , {t}^{′} ) ∉ {V}_{k , {t}^{′}}}^{K} \sqrt{{η}_{j ( i , {t}^{′} )}^{( {t}^{′} - ( {t}^{′} - 1 ) )}} {g}_{k}^{H} {g}_{j ( k , i - k + {t}^{′} - 1 )} {x}_{j ( i , {t}^{′} )} + {n}_{k , {t}^{′} {t}^{′}}^{( {t}^{′} )}\end{matrix} , \qquad [ 26 ]$$

Where y_{k,t′}^{(t′)} is obtained from yₖ^{(t)} after performing interference cancellation, and n_{k,t′}^{(t′)} is the corresponding noise at the k-th user 14.

Denoting

$${\overline{y}}_{k}^{( {t}^{′} )} = [ \begin{matrix}{\overline{y}}_{k , 1}^{( {t}^{′} )} \\ {\overline{y}}_{k , 2}^{( {t}^{′} )} \\ ⋮ \\ {\overline{y}}_{k , {t}^{′}}^{( {t}^{′} )}\end{matrix} ] , \overline{x} {=}^{Δ} {[ \begin{matrix}{x}_{j ( k , {t}^{′} + 1 )} & {x}_{j ( k , {t}^{′} + 2 )} & … & {x}_{j ( k , K - 1 )}\end{matrix} ]}^{T} , \\ {\overline{n}}_{k}^{( {t}^{′} )} {=}^{Δ} [ \begin{matrix}{n}_{k , 1}^{( {t}^{′} )} \\ {n}_{k , 2}^{( {t}^{′} )} \\ ⋮ \\ {n}_{k , {t}^{′}}^{( {t}^{′} )}\end{matrix} ] , \qquad [ 27 ]$$

and

Āₖ^{(t′)}=Aₖ^{(t′)}∘E_{η}^{(t′)}, [28]

where the matrices
Aₖ^{(t′)}∈ [symbol] ^{t′×(K-t′-1)} and Eₖ^{(t′)}∈ [symbol] ^{t′×(K-t′-1)} in equation [28] are defined as

$$\begin{matrix}{A}_{k}^{( {t}^{′} )} {=}^{Δ} [ \begin{matrix}{g}_{k}^{H} {g}_{j ( k , 1 )} & {g}_{k}^{H} {g}_{j ( k , 2 )} & … & {g}_{k}^{H} {g}_{j ( k , K - {t}^{′} - 1 )} \\ {g}_{k}^{H} {g}_{j ( k , 2 )} & {g}_{k}^{H} {g}_{j ( k , 3 )} & … & {g}_{k}^{H} {g}_{j ( k , K - {t}^{′} )} \\ ⋮ & ⋮ & & ⋮ \\ {g}_{k}^{H} {g}_{j ( k , {t}^{′} )} & {g}_{k}^{H} {g}_{j ( k , {t}^{′} + 1 )} & … & {g}_{k}^{H} {g}_{j ( k , K - 2 )}\end{matrix} ] , \\ and & [ 29 ] \\ {E}_{η}^{( {t}^{′} )} {=}^{Δ} [ \begin{matrix}\sqrt{{η}_{j ( k , {t}^{′} + 1 )}^{( {t}^{′} )}} & \sqrt{{η}_{j ( k , {t}^{′} + 2 )}^{( {t}^{′} )}} & … & \sqrt{{η}_{j ( k , K + 1 )}^{( {t}^{′} )}} \\ \sqrt{{η}_{j ( k , {t}^{′} + 1 )}^{( {t}^{′} - 1 )}} & \sqrt{{η}_{j ( k , {t}^{′} + 2 )}^{( {t}^{′} - 1 )}} & … & \sqrt{{η}_{j ( k , K + 1 )}^{( {t}^{′} - 1 )}} \\ ⋮ & ⋮ & & ⋮ \\ \sqrt{{η}_{j ( k , {t}^{′} + 1 )}^{( {t}^{′} - ( {t}^{′} - 1 ) )}} & \sqrt{{η}_{j ( k , {t}^{′} + 2 )}^{( {t}^{′} - ( {t}^{′} - 1 ) )}} & … & \sqrt{{η}_{j ( k , K + 1 )}^{( {t}^{′} - ( {t}^{′} - 1 ) )}}\end{matrix} ] . & [ 30 ]\end{matrix}$$

then equation [26] can be re-written in vector form as

y̅ₖ^{(t′)}=Āₖ^{(t′)}x̅+n̅ₖ^{(t′)}, [31]

It can be seen that Āₖ^{(t′)} is a t′×(K−t′−1) matrix. Since t′≥(K−t′−1), Āₖ^{(t′)} is full column rank, zero-forcing (ZF) linear processing can be used to detect all of the remaining symbols without inter-user interference.

With ZF linear decoding, y̅ₖ^{(t′)} is first processed by multiplying it with the pseudo inverse of Āₖ^{(t′)} as

\tilde{r}ₖ^{(t′)}=Z^{T}y̅ₖ^{(t′)}=Z^{T}Āₖ^{(t′)}x̅+Z^{T}n̅ₖ^{(t′)}, [32]

where

$${Z}^{T} {=}^{Δ} {( {( {\overline{A}}_{k}^{( {t}^{′} )} )}^{H} {\overline{A}}_{k}^{( {t}^{′} )} )}^{- 1} {( {\overline{A}}_{k}^{( {t}^{′} )} )}^{H} . \qquad [ 33 ]$$

Then, x_{j(k,t′+n)} is detected from the nth element of \tilde{r}ₖ^{(t′)}. Since Z^{T}Āₖ^{(t′)}=I_{K-(t′+1)}, then equation [31] becomes

\tilde{r}ₖ^{(t′)}=x̅+Z^{T}n̅ₖ^{(t′)}, [34]

and hence, the n-th element of \tilde{r}ₖ^{(t′)} is

\tilde{r}_{k,n}^{(t′)}=x_{j(k,t′+n)}+zₙ^{T}n̅ₖ^{(t′)}, [35]

Thus, the corresponding spectral efficiency of equation [35] is

$$\begin{matrix}{R}_{k}^{dl , ( {t}^{′} + n )} = 𝔼 \{ {log}_{2} ( 1 + \frac{1}{{‖ {z}_{n} ‖}^{2}} ) \} \\ = 𝔼 \{ {log}_{2} ( 1 + \frac{1}{{[ {( {( {\overline{A}}_{k}^{( {t}^{′} )} )}^{H} {\overline{A}}_{k}^{( {t}^{′} )} )}^{- 1} ]}_{nn}} ) \} .\end{matrix} \qquad [ 36 ]$$

It will be seen that, in the BC phase, after t=┌(K−1)/2┐ time-slots, the k-th user has received t′ signals. Furthermore, it has decoded t′ symbols. So, it can subtract all t′ detected symbols from each received signal to obtain t′ equations, each equation has (K−t′−1) unknown variables. Since t=┌(K−1)/2┐, the number of equations is greater than or equal to the number of unknown variables. Therefore, the k-th user can detect all remaining (K−t′−1) symbols via zero-forcing linear processing or other linear processing technique. In alternative embodiments, other linear processing techniques may alternatively be used, for example maximum-ratio combining (MRC) or minimum mean-squared error (MMSE).

It is noted that in conventional transmission protocols, the successful decoding of the signals/symbols received in the first ┌(K−1)/2┐ is not performed or required. In contrast, in the presently proposed transmission protocol, in particular for the BC phase, the signals/symbols of first ┌(K−1)/2┐ need to be successfully decoded to enable all remaining symbols to be detected without user interference, using the ZF technique in preferred embodiments. Due to the use of a massive antenna array at the relay station 12, the interference and noise can be cancelled out, and hence, the signal detections of the first ┌(K−1)/2┐ time-slots are successful with very high probability.

It will be seen that in preferred embodiments of the invention ┌(K−1)/2┐+1 time-slots are required for information exchange among the K users, while the conventional transmission protocol requires in total K time-slots. As a result, compared to the conventional transmission protocol, embodiments of the invention offer significantly improved system performance.

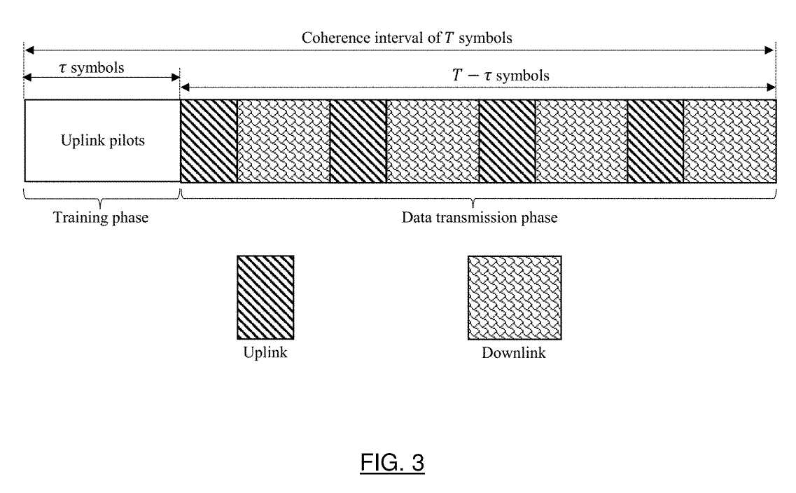

FIG. 3 illustrates how, in preferred embodiments, information is exchanged between the user device devices 14 and the relay station 12 using time division duplexing (TDD). The uplink and downlink transmission use the same frequency band but different time-slots. More precisely, for each coherence interval of length T symbols, the transmission may occur in three phases: an uplink training phase, an uplink data transmission phase, and a downlink transmission phase. A duration of length symbols may be used for the uplink training, and the remaining duration is used for the data payload transmission phases.

The invention is not limited to the embodiment(s) described herein but can be amended or modified without departing from the scope of the present invention.

1. A method of communicating signals amongst a plurality of user communication devices across a wireless communications network using a telecommunications relay station, the method comprising:
transmitting, from each of said user devices, a respective user signal to said relay station;
broadcasting, from said relay station to each of said user devices, the user device signals over a plurality of transmission time slots,
wherein said broadcasting involves broadcasting in each of said time slots a respective broadcast signal comprising a combination of said received user device signals,
the method further comprising:
receiving, at each of said user devices in each time slot, the respective broadcast signal for the respective time slot, and
for a first of said time slots, at each of said user devices,
removing, from the respective received broadcast signal, the respective user signal of the respective user device, and subsequently
detecting, from the respective received broadcast signal, a respective user signal from another of said user devices, and
for subsequent time slots, at each of said user devices,
removing, from the respective received broadcast signal, the respective user signal of the respective user device,
removing, from the respective received broadcast signal, the or each respective user signal from another of said user devices detected in the or each previous time slot, and subsequently
detecting, from the respective received broadcast signal, a respective user signal from another of said user devices,
and determining, at each user device, from the respective user signal from said another of said user devices detected in each previous time slot, and from the respective received broadcast signals for said first time slot and said subsequent time slots, the respective user signal of each user device in respect of which the respective user signal has not been detected.

2. The method of claim 1, wherein there are K of said user devices, and wherein said plurality of transmission time slots consists of ┌(K−1)/2┐ time slots.

3. The method of claim 2, wherein said determining involves determining the respective user signal of K−┌(K−1)/2┐−1 user devices in respect of which the respective user signal has not been detected.

4. The method of claim 1, wherein said determining involves calculating the respective user signals using linear processing.

5. The method of claim 4, wherein said linear processing is zero-forcing linear processing.

6. The method of claim 4, wherein said linear processing is maximum-ratio combining (MRC) or minimum mean-squared error (MMSE).

7. The method of claim 1, wherein said respective broadcast signal comprises a linear combination of said received user device signals.

8. The method of claim 7, wherein said linear combination is created using maximum-ratio combining (MRC) or minimum mean-squared error (MMSE) linear processing.

9. The method of claim 1, wherein said detecting comprises decoding the respective received broadcast signal to determine the respective user signal from another of said user devices.

10. The method of claim 9, wherein said decoding involves using maximum likelihood decoding, minimum distance encoding or syndrome encoding.

11. The method of claim 1, wherein said relay station is a multi-way massive MIMO relay station.

12. The method of claim 1, wherein said transmitting and said broadcasting are performed using a common frequency band.

13. The method of claim 1, wherein said transmitting and said broadcasting are performed using time-division duplexing (TDD).

14. A telecommunications system comprising a plurality of user communication devices in communication across a wireless communications network using a telecommunications relay station, wherein each of said user devices is configured to transmit a respective user signal to said relay station, said relay station being configured to broadcast, in each of a plurality of time slots to each of said user devices, a respective broadcast signal comprising a combination of said user device signals, and wherein each of said user devices is configured to receive, in each time slot, the respective broadcast signal for the respective time slot, and
for a first of said time slots,
to remove, from the respective received broadcast signal, the respective user signal of the respective user device, and subsequently
to detect, from the respective received broadcast signal, a respective user signal from another of said user devices, and
for subsequent time slots,
to remove, from the respective received broadcast signal, the respective user signal of the respective user device,
to remove, from the respective received broadcast signal, the or each respective user signal from another of said user devices detected in the or each previous time slot, and subsequently
to detect, from the respective received broadcast signal, a respective user signal from another of said user devices,
and wherein each user device is configured to determine, from the respective user signal from said another of said user devices detected in each previous time slot, and from the respective received broadcast signals for said first time slot and said subsequent time slots, the respective user signal of each user device in respect of which the respective user signal has not been detected.

15. The system of claim 14, wherein said relay station is a massive MIMO relay station.
